(19) United States
(12) Patent Application Publication
(10) Pub. No.: US 2013/0126456 A1
(43) Pub. Date: May 23, 2013

(54) Bracket for a structure

(71) Applicant: Michael Pfotenhauer, Mill Valley, CA (US)

(72) Inventor: Michael Pfotenhauer, Mill Valley, CA (US)

(73) Assignee: OSPREY CHILD SAFETY PRODUCTS, LLC, Cortez, CO (US)

(21) Appl. No.: 13/359,041

(22) Filed: Jan. 26, 2012

(30) Foreign Application Priority Data
Nov. 18, 2011 (GB) 1119900.7

(51) Int. Cl. A47B 43/00; F16M 13/02

(52) U.S. Cl. 211/200; 248/224.8

(57) ABSTRACT

The invention relates to a bracket for a collapsible frame. The bracket has a frame holding recess configured to receive and/or releasably secure a portion of a frame of a structure therein and an arm holding recess configured to receive and/or releasably secure a portion of an arm of a structure therein. The body has an axis around which an arm fixed to the bracket can turn, with respect to a frame held by the bracket, between an open position and closed position. The body has a tab or formation configured in the arm holding region to inhibit movement of an arm located in the bracket between an open position and closed position. The bracket has a brace releasably attached to the body and configured to further inhibit movement of an arm located in the bracket. The invention also relates to a structure having such a bracket.

### TECHNICAL FIELD

The invention relates to bracket, such as a bracket for a foldable child carrier that is typically carried on the back of a parent. The invention also relates to a structure having such bracket for foldable child carriers or bicycle carriers or such devices.

### BACKGROUND ART

Known devices, such as child carriers, can be foldable for storage or transportation purposes. By way of example, a child carrier has a frame and webbing configured to enable an adult to carry a child on their back in a seat-type structure. Such seats have different components, including a back-support frame that is positioned against a user's back, a cot frame in which a child would be suspended and a support frame that can be used to stand the carrier temporarily on the ground. The frame of each component can be connected to another using brackets that allow relative movement between the components to enable the carrier to fold, or expand to enable it to stand independently.

Brackets, however, must be configured to avoid uncontrolled collapse of such a carrier because it is a safety critical application. Known standards include EN 13209-1 2004 and ASTMS F2549-09a.

### SUMMARY OF THE INVENTION

An aspect of the invention resides in a bracket for a collapsible frame, such as a child carrying device. The bracket comprises: a body, said body having: a frame holding region or recess configured to receive and/or releasably secure a portion of a frame of a structure therein; and an arm holding region or recess configured to receive and/or releasably secure a portion of an arm of a structure therein. The arm can be part of another frame or structure. The body has an axis around which an arm fixed to the bracket can turn, with respect to a frame held by the bracket, between an open position and closed position. The axis functions as a rotation point and can be provided by a pin within the bracket or by a fixing that can also be used to secure the arm within the bracket. The body has a tab or formation configured in the arm holding region to inhibit movement of an arm located in the bracket between a first or open position and a second, or closed position. The bracket has a brace releasably attached to the body and configured to further inhibit movement of an arm located in the bracket. The material body can comprise a resilient material such that it functions as a spring. The brace can function as a spring.

One or more tabs function to control the position of the arm within the bracket. The tabs can be configured to provide notches or slots in which an arm can be biased.

The brace can be configured adjacent the tab to inhibit flexing of the body in the region of the tab. The brace can be configured to increase the force required to turn an arm configured in the bracket between an open and closed position. By way of example, the brace can be configured to inhibit flexing of the bracket in the region of one or more tabs. The brace can be configured to inhibit flexing in the region of the bracket that flexes to accommodate movement of an arm therein.

The bracket can be configured to inhibit flexing of the body in the region of the tab when an arm configured in the bracket is moved from an open position to a closed position. The bracket can be configured to allow, or ease flexing of the body in the region of the tab when an arm configured in the bracket is moved from a closed position to an open position.

The brace can be centered on the axis. The brace can be substantially circular. The brace can be substantially planar. The brace can be configured to extend across the surface of the body from the point at which the axis passes through the body to the region adjacent the tab. The brace can be configured to have reinforcement. The brace can have a three-dimensional profile. The brace can have a profile configured to increase the flexibility in one direction and decrease the flexibility in another direction. The brace can have strengthening means configured to increase the stiffness of the brace. The brace can be configured to inhibit rotation with respect to the body when fixed thereto. The brace can be keyed to the body. The bracket can have a brace configured on each side of the body.

The brace can be configured to be adjustable on the bracket such that the force required to move the arm between one position and another position can be adjusted. By way of example, the brace can be rotated upon the bracket and the position of the brace with respect to the body can change the flexibility of the body and the bracket.

A further aspect of the invention resides in a structure having: a frame; a bracket releasably secured to the frame; and an arm, pivotally connected to the frame via the bracket and configured to allow the movement of the between an open position and closed position, wherein the bracket has a body having: a region or recess configured to receive and/or releasably secure a portion of the frame therein; and a region or recess configured to receive and/or releasably secure a portion of the arm therein, wherein the arm is connected to the body to turn about an axis with respect to a frame, and wherein the body has a tab or formation configured to inhibit movement of the arm between the open position and closed position; and a brace releasably attached to the body and configured to further inhibit movement of the arm located in the bracket.

A further aspect of the invention resides in a foldable child carrying device having a structure and/or a bracket according to the invention.

### BRIEF DESCRIPTION OF THE DRAWINGS

The invention will now be described in more detail with reference to the accompanying drawings wherein:

FIG. 1 is a schematic diagram of a bracket of the invention attached to a frame and connecting an arm thereto;

FIG. 2 is a perspective schematic view of the bracket of FIG. 1 without a frame or arm connected to the bracket;

FIG. 3 is a further schematic view of the bracket, frame and arm of FIG. 1; and

FIG. 4 is a schematic view of a structure according the invention having four brackets according to the invention.

### DETAILED DESCRIPTION OF THE INVENTION

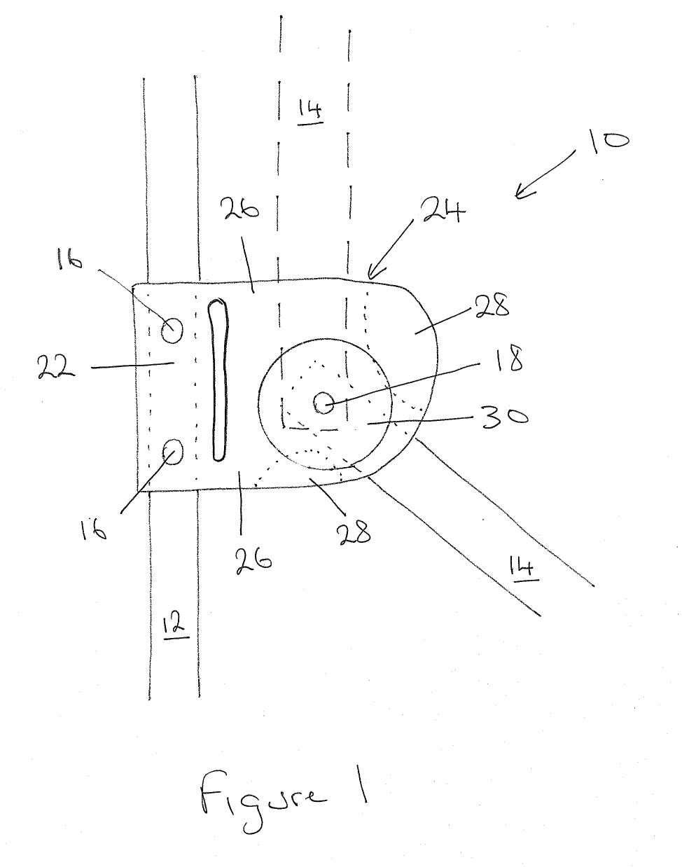

FIG. 1 shows a bracket 10 connected to a frame 12 and an arm 14. The bracket is connected to the frame using a fixing 16, such as a bolt or rivet. The arm is connected to the bracket using a joint or fixing 18, which can be an axle provided in the bracket 10 or it may be a fixing, such as a bolt or pin, which passes through the bracket and the arm. The fixing 18, or joint, functions to allow the arm to rotate about the axis with respect to the frame 12.

The bracket 10 has a body formed to provide a frame recess 22 in which the frame is located and an arm recess 24 in which the arm 14 is pivotable about the joint 18. The arm recess is defined by one or more walls 26. The joint or axis 18 extends between across the space defined by the wall or walls.

The external surface of the walls 26 is substantially planar, and the internal dimensions of the arm recess 24 correspond to the dimensions of the arm 14 located therein. To inhibit free rotation of the arm in the recess tabs 28 are provided on the internal surface of the or each wall 26. The tabs function to partially or controllably block the path of the arm within the space 24 between the walls 26.

The position of the or each tab 28 within the arm recess 24 defines positions in which the arm 14 can rest, or be temporarily secured. In FIG. 1 the arm is shown positioned between two tabs and extends at an angle of approximately 45-degrees from the frame 12 (an open position). The arm 14 can, however, can be rotated anti-clockwise, as viewed, past a tab 28 into a position in which the arm is substantially parallel to the frame, as indicated by the dashed line (a closed position).

To move between these positions the arm must compress and/or displace the material of the bracket 10, forcing a path through the restricted space between the walls 26, and between the tabs. The bracket 10 comprises a resilient material that allows temporary deformation, or flex, of the bracket before returning to its original size and configuration. By way of example, at least 50 Nm of force is required to displace the arm from one position to the other.

A brace 30 is attached to the bracket. The brace is fixed to the bracket at the joint 18, or axis. The brace can be attached using the same fixing, or axle, used to secure the arm 14 to the body 20. Additionally or alternatively it can be fixed to the body directly 20. The brace can be fixed to the bracket 10 using the same fixing that is used to secure the bracket to the frame 12.

The brace 30 can be made of a material with different resilient properties to those of the body 20. By way of example, the body can be made of a plastic and the brace can be made of metal. In the examples shown the brace is a 1 mm thick steel washer. The brace acts upon the bracket to inhibit and/or control movement of the arm within the bracket 10. The brace increases the force required to move the arm between different positions within the arm space 24. The brace functions to inhibit movement by inhibiting deformation of the body of the bracket 10.

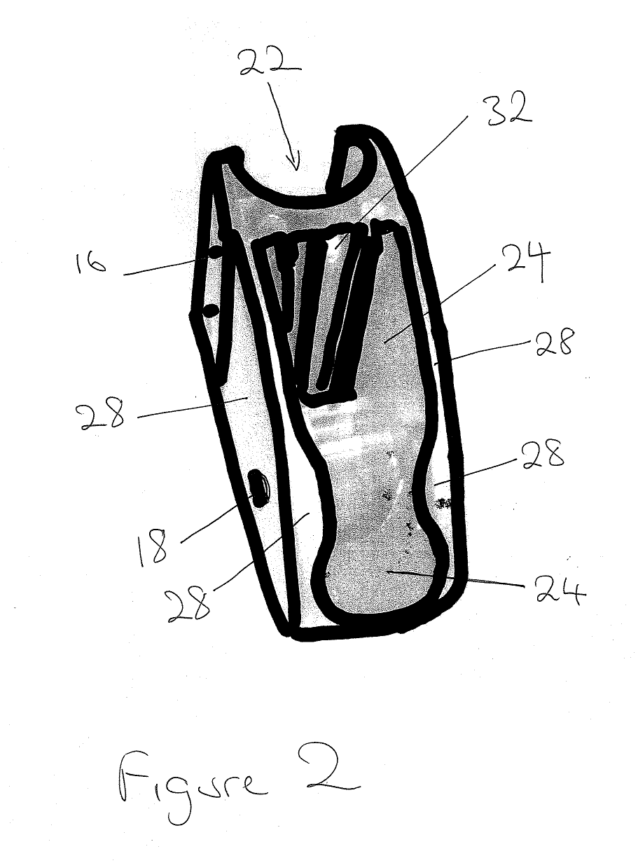

FIG. 2 shows the bracket 10 without a frame or arm located therein, and without a brace fixed thereto. This perspective view indicates, by way of example, the shape and form of the tabs 28 located on the walls 26 of the body 20 of the bracket 10. The arm recess is divided in two by the tabs.

Note that the tab configuration is different from that shown in FIG. 1. The configuration of a tab, tabs or notches can vary according to the particular application. The brace 30 can be configured to compliment the tab configuration such that the bracket can meet the required standard in different applications.

In the upper region, as viewed, an arm 14 rotating about the fixing 18 can be positioned adjacent the frame recess 22, and a frame, if it were positioned therein. Spacers 32 are provided in the bracket to inhibit the arm 14 from rotating so far that it contacts with the frame 12 thus avoiding a trap hazard.

In the lower region, as viewed, an arm can be held between the tabs 28 and a portion of the wall 26 between the tabs. In the example shown the aperture of the recess 24 in the lower region has a profile corresponding to the cross-section profile of an arm that would extend from the bracket 10—in the Figure shown the arm would be a circular tube.

The tabs 28 define spaces or positions in which the arm 14 is not applying a force to the bracket and there is no deformation to the body 20. Additionally or alternatively, the tabs 28 can extend over the inner surface of the wall 26 such that notches or slots are provided. By way of example, the arm can rest in an open position between two tabs, or it can rest in a notch. Either way, movement between the open and closed position requires the arm to displace the bracket material to enable the arm to move to the closed position.

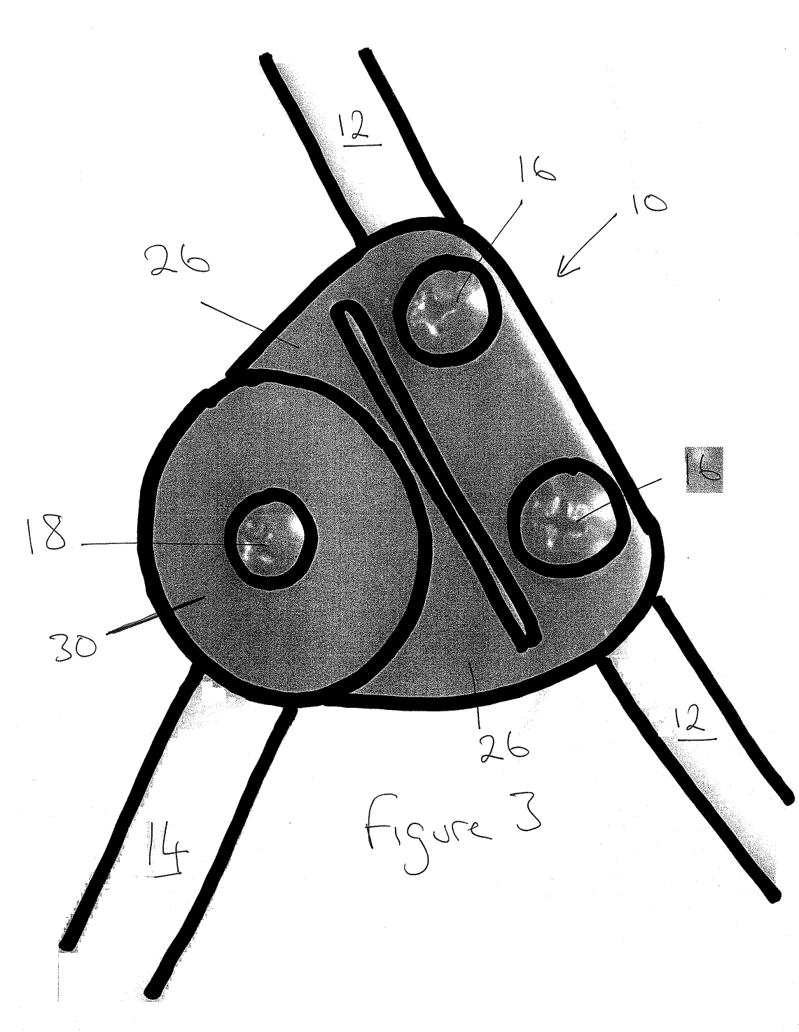

FIG. 3 shows a side view of the bracket 10 attached to a frame 12 and having an arm 14 extending from the bracket in an open position. The brace is fixably attached to the axis 18. The brace 30 is configured to cover substantially the wall 26 that defines the arm recess 24, thus inhibiting flexing of the body 20 in this portion of the bracket 10. The brace can extend beyond the edge of the walls 26.

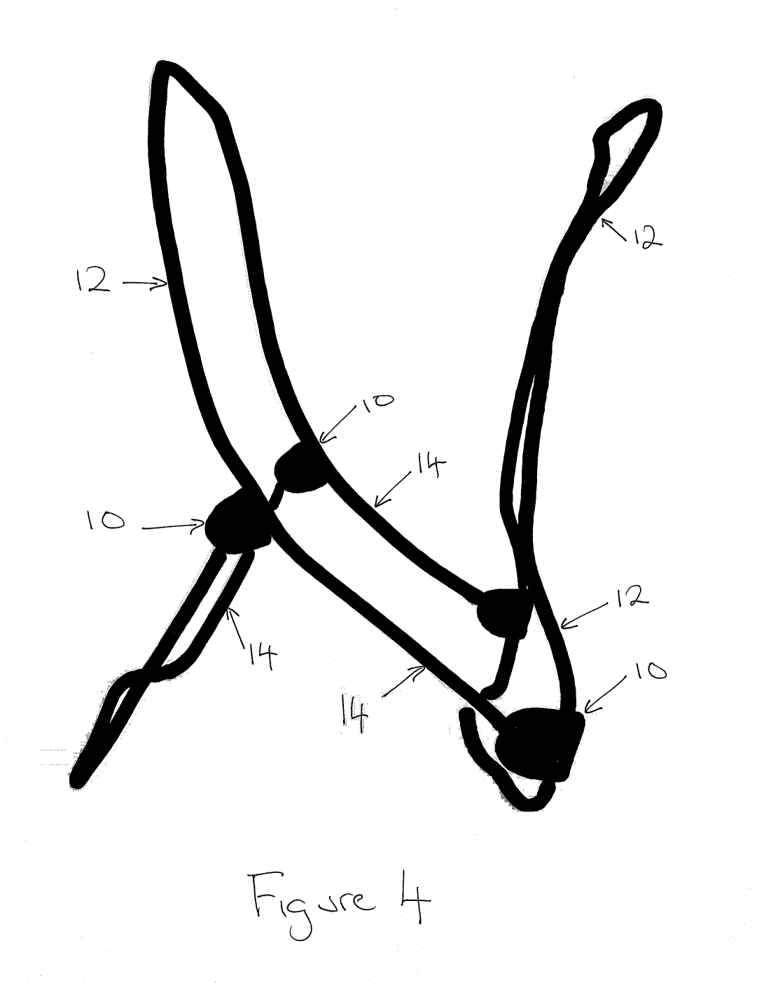

FIG. 4 shows a perspective view of a structure, like the type used to manufacture a child-carrying device. Brackets 10 are shown fixed to a frame 12 about which an arm 14, or another frame 12, can turn. The term arm 14 is not limiting and is to be understood to mean the portion extending from the bracket.

The aforementioned brace can be used to implement and complement a bracket that performs to the required safety standards when assembled together with a frame structure, as shown in FIG. 4. The brace 30 can be configured to work together with the bracket 10 to achieve the required performance.

Factors that the brace can be configured to compliment can be the tab shape, tube shape, material of the bracket and material of the shoe. By way of example, the thickness of the brace can be increased to reduce its flexibility, which in turn further inhibits flexing of the bracket to accommodate movement of the arm between open and closed positions.

A bracket can be configured with two or more braces 30. The bracket 10 can be configured with at least one brace on each side of the body 20 of the bracket to control the movement of the tabs 28 during movement of the arm.

The shape of the bracket can also be adjusted and/or configured to adjust the flexing of the bracket to accommodate movement of the arm between open and closed positions. The bracket shown in the Figures is, by way of example, a circular washer that is fixed to the joint or axis 18. The dimensions of the washer can be adjusted to adjust the flexing of the bracket by, for example, increasing the thickness and/or increasing the diameter and/or changing the material properties of the brace 30.

The bracket 10 can also be configured such that the arm-arrangement, which is the ability of the bracket 10 and brace 30 to control the relative movement between an open and closed position, can be replicated on the same bracket such that two or more arms are connected to the bracket and both arms are turnable about their respective joints.

The present invention has been described above purely by way of example, and modifications can be made within the spirit and scope of the invention, which extends to equivalents of the features described and combinations of one or more features described herein. The invention also consists in any individual features described or implicit herein or shown or implicit in the drawings or any combination of any such features or any generalisation of any such features or combination.

What is claimed is:

1. A bracket for a collapsible frame, the bracket comprising:
a) a body having:
i) a frame holding region or recess configured to receive and/or releasably secure a portion of a frame of a structure therein; and
ii) an arm holding region or recess configured to receive and/or releasably secure a portion of an arm of a structure therein,
wherein the body has an axis around which an arm fixed to the bracket can turn, with respect to a frame held by the bracket, between an open position and closed position, and
wherein the body has a tab or formation configured in the arm holding region to inhibit movement of an arm located in the bracket between an open position and closed position; and
b) a brace releasably attached to the body and configured to further inhibit movement of an arm located in the bracket.

2. The bracket according to claim 1, wherein the brace is configured adjacent the tab to inhibit flexing of the body in the region of the tab such that the force required to turn an arm configured in the bracket between an open and closed position is increased.

3. The bracket according to claim 1, wherein the bracket is configured to i) inhibit flexing of the body in the region of the tab when an arm configured in the bracket is moved from an open position to a closed position and ii) allow flexing of the body in the region of the tab when an arm configured in the bracket is moved from a closed position to an open position.

4. The bracket according to claim 1, wherein the brace is centered on the axis.

5. The bracket according to claim 1, wherein the brace is substantially circular.

6. The bracket according to claim 1, wherein the brace is substantially planar.

7. The bracket according to claim 1, wherein the brace is configured to extend across the surface of the body from the point at which the axis passes through the body to the region adjacent the tab.

8. The bracket according to claim 1, wherein the brace has strengthening means configured to increase the stiffness of the brace.

9. The bracket according to claim 1, wherein a brace is configured on each side of the body.

10. A structure having:
a frame;
a bracket releasably secured to the frame; and
an arm, pivotally connected to the frame via the bracket and configured to allow the movement of the between an open position and closed position, wherein the bracket has a body comprising resilient material, said body having:
a region or recess configured to receive and/or releasably secure a portion of the frame therein; and
a region or recess configured to receive and/or releasably secure a portion of the arm therein,
wherein the arm is connected to the body to turn about an axis with respect to a frame, and wherein the body has a tab or formation configured to inhibit movement of the arm between the open position and closed position; and
a brace releasably attached to the body and configured to further inhibit movement of the arm located in the bracket.

11. A foldable child carrying device having a structure according to claim 10.
